(19) United States
(12) Patent Application Publication
(10) Pub. No.: US 2026/0353003 A1
(43) Pub. Date: Nov. 5, 2026

(54) CONTROLLING A WORLD VOLUME FOR AN AUDIO DEVICE

(71) Applicant: Logitech Europe S.A., Lausanne (CH)

(72) Inventors: Gaurav Bradoo, San Francisco, CA (US); Jeremy Bruck, Brush Prairie, WA (US); Charles E. Dugger, Lausanne (CH); Grace Hina Lee, Oakland, CA (US); Libao Wu, Fremont, CA (US); Yena Ahn, San Jose, CA (US)

(21) Appl. No.: 19/196,634

(22) Filed: May 1, 2025

(51) Int. Cl. H04R 3/04; G10K 11/178; H04R 1/10; H04R 29/00

(52) U.S. Cl. CPC H04R 3/04; G10K 11/17827; G10K 11/17885; H04R 1/1041; H04R 1/1083; H04R 29/008; G10K 2210/1081; G10K 2210/3056; H04R 2430/01; H04R 2460/01

(57) ABSTRACT

The present disclosure relates to an audio device and method for controlling ambient sound through a unified system. The device integrates passive isolation, active noise cancellation (ANC), and passthrough functionality to provide a seamless and customizable auditory experience. By employing a combination schema, users can adjust noise attenuation and amplify specific frequency ranges, such as human voices, to achieve a flat or tailored audio response. The system incorporates intuitive controls, such as dials or sliders, to modify settings in real time, and visual indicators to display adjustments.

### BACKGROUND

Existing headsets offer limited control over ambient sound through discrete modes such as Active Noise Cancellation (ANC) on/off and transparency mode, resulting in abrupt changes in sound levels. There is a need for more efficient methods of ambient sound management.

### BRIEF SUMMARY

A system may include one or more computers configured to perform specific operations or actions through the use of software, firmware, hardware, or a combination of these. The system may execute operations by virtue of having instructions installed that, when executed, cause the system to perform the described actions. Similarly, computer programs may be configured to perform particular operations by including instructions that, when executed by a data processing apparatus, cause the apparatus to carry out the actions.

One general aspect of the present disclosure includes a method for controlling an audio device. The method may include attenuating a first range of frequencies using passive isolation. The method may also include attenuating a second range of frequencies using active noise cancellation. Additionally, the method may introduce a third range of frequencies using passthrough functionality from one or more microphones integrated into the audio device. This may involve detecting and capturing ambient sound from the surrounding environment, creating an audio signal based on the captured ambient sound, and outputting the audio signal through one or more transducers configured to convert the signal into sound via speakers integrated into the audio device. The method may further include receiving a combination schema from a signal input element and combining the first, second, and third ranges of frequencies into a desired frequency response based on the combination schema. Any audio signals processed and output may be confined to an audible frequency range of approximately 20 Hz to 20 kHz.

Other embodiments of the present disclosure may include corresponding systems, apparatus, and computer programs stored on one or more computer-readable media, each configured to perform the actions described.

In certain implementations, the method may include additional features. For example, the desired frequency response may include a flat audio response, and the combination schema may be configured to add gain to the flat audio response. The method may also include decreasing a system volume below an environmental baseline volume and engaging a visual indicator to display that the audio device has reduced the system volume. The visual indicator may include a number of LEDs or colors of LEDs coupled to one or both earphones on the audio device. In some implementations, the system volume may gradually and automatically return to the environmental baseline volume over a configurable time period. Usage statistics relating to the deployment of the audio device's focus features may also be aggregated and displayed.

In some embodiments, the method may further include modifying the combination schema via a dial situated on one earphone of the audio device. Adjustments made using the dial may include settings to modify the level of attenuation from active noise cancellation and the level of gain from passthrough functionality. In some embodiments, adjusting the dial may increase the prominence of voice frequencies compared to an environmental baseline volume. The method may also include adjusting the overall audio volume of the device via a separate dial situated on the opposite earphone of the audio device.

In certain implementations, introducing a third range of frequencies via passthrough functionality may further include amplifying specific frequencies, such as those associated with human voices. The audio device may also be adjustable while worn, allowing for modifications to physical characteristics that affect passive isolation.

In some embodiments, the system may include a pair of earphones configured to perform operations such as passive isolation of a first range of frequencies, active noise cancellation of a second range of frequencies, and passthrough functionality for introducing a third range of frequencies. The system may detect and capture ambient sound from the environment surrounding the earphones, output audio signals through transducers integrated into the earphones, and combine the first, second, and third ranges of frequencies into a desired frequency response based on a combination schema. As with the method, any audio signals processed and output may be confined to an audible frequency range of approximately 20 Hz to 20 kHz.

Some embodiments of the system may include additional features. For example, the earphones may be configured to match active noise cancellation with passive isolation to create a flat audio response, while a dial coupled to one earphone may allow the user to add gain to this flat audio response. The system may include a neutral setting on the dial that corresponds to an environmental baseline world volume. The dial may include separate portions for raising and lowering the level of active noise cancellation attenuation and passthrough gain, while maintaining the flat audio response throughout. In some implementations, the system may display usage statistics related to focus features of the audio device, providing aggregated data for analysis or optimization.

The described techniques may be implemented in hardware, methods or processes, or computer software stored on computer-accessible media.

Some embodiments incorporate a method of controlling an audio device, the method comprising: attenuating, via passive isolation, a first range of frequencies; attenuating, via active noise cancelation, a second range of frequencies; introducing, via passthrough from one or more microphones on the audio device, a third range of frequencies, comprising: detecting and capturing an ambient sound from an environment surrounding the audio device; creating an audio signal based on the ambient sound; outputting, via one or more transducers configured to convert the audio signal into a sound and output the sound through one or more speakers integrated into the audio device; receiving, from a signal input element, a combination schema; and combining the first range of frequencies, the second range of frequencies, and the third range of frequencies into a desired frequency response based on the combination schema. In some aspects, the desired frequency response is a substantively flat audio response. In certain embodiments, the combination schema adds gain to the flat audio response. The combination schema may be modified via a dial situated on a first earphone on the audio device. In some aspects, a first portion of a setting adjustable via the dial modifies an amount of attenuation from active noise cancelation, and a second portion of the settings adjustable via the dial modifies an amount of gain from passthrough. In certain embodiments, adjusting the dial increases a level of voice frequencies in comparison to an environmental baseline volume. In some embodiments, a volume of the audio device is adjustable via an additional dial situated on a second earphone on the audio device. In some embodiments, introducing, via passthrough from one or more microphones on the audio device, a third range of frequencies, further comprises amplifying specific frequencies associated with a human voice. The method may further include decreasing a system volume lower than an environmental baseline volume; and engaging a visual indicator capable of displaying that the audio device has decreased the system volume. The visual indicator can be a number of LEDs coupled to one or both of a first earphone or a second earphone on the audio device. In some aspects, the visual indicator is a color of LEDs coupled to one or both of a first earphone or a second earphone on the audio device. In some cases, the system volume gradually and automatically returns to an environmental baseline volume over a configurable time period. In certain embodiments, there exists a neutral performance setting, wherein the neutral performance setting corresponds to an environmental baseline volume. The method may further include modifying the passive isolation by adjusting a physical characteristic of the audio device, wherein the audio device is capable of being adjusted while worn.

In some embodiments, a system comprises: a pair of earphones, the pair of earphones being configured to perform operations including: attenuating, via passive isolation, a first range of frequencies; attenuating, via active noise cancelation, a second range of frequencies; introducing, via passthrough from external microphones on the pair of earphones, a third range of frequencies, further comprising; detecting and capturing an ambient sound from an environment surrounding the pair of earphones; outputting, via one or more transducers configured to convert an audio signal into a sound and output the sound through one or more speakers integrated into the pair of earphones; receiving, from a signal input element, a combination schema; and combining the first range of frequencies, the second range of frequencies, and the third range of frequencies into a desired frequency response based on the combination schema. In some cases, the system further comprises: the pair of earphones being configured to perform operations including: matching active noise cancelling with passive isolation to create a flat audio response; and a first dial coupled to a first earphone on the pair of earphones, configured to perform operations including: adding gain to the flat audio response. In some embodiments, the system further comprises the pair of earphones being configured to perform operations including: matching active noise cancelling with passive isolation to create a flat audio response;

In certain embodiments, the system further comprises a first dial coupled to a first earphone on the pair of earphones, the first dial comprising a first half and a second half; the first half configured to perform operations including: raising and lowering a level of active noise cancelling attenuation; and the second half configured to perform operations including: raising and lowering a level of passthrough gain. In certain embodiments of the system, a flat audio response is maintained throughout the functioning and usage of the system. In certain implementations, the system may further comprise: a neutral setting on the first dial, capable of generating an environmental baseline world volume. In some embodiments, usage statistics relating to deployment of an audio device's focus features are aggregated and displayed.

Additional embodiments incorporate a method of controlling an audio device, the method comprises: attenuating, via passive isolation, a first range of frequencies; attenuating, via active noise cancellation, a second range of frequencies; introducing, via passthrough functionality from one or more microphones integrated into the audio device, a third range of frequencies. In some embodiments, the step of introducing passthrough functionality can further comprise detecting and capturing ambient sound from an environment surrounding the audio device; creating an audio signal based on the captured ambient sound; outputting the audio signal via one or more transducers configured to convert the signal into sound and deliver it through speakers integrated into the audio device; and transitioning the audio device from a first state to a second state via a transitional mode.

In certain implementations, the transitional mode between the first state and the second state includes: receiving, from a signal input element, a combination schema to configure the transitional mode and its parameters; and gradually blending levels of attenuation from passive isolation, active noise cancellation, and passthrough gain based on the combination schema. In some implementations, the transitional mode is triggered by at least one of detecting a predefined user input on a physical control interface of the audio device; receiving a signal from a connected external device; or detecting environmental changes based on ambient sound captured by the microphones. In certain embodiments, a duration of the transitional mode is adjustable and configured to complete over a predefined time period ranging from 1 second to 1 hour. Yet other embodiments include: engaging a visual indicator during the transitional mode to display a progression of the transition, wherein the visual indicator comprises a plurality of LEDs or an LED array that dynamically updates. In certain implementations, the combination schema includes parameters for: defining the range of frequencies blended during the transitional mode; and specifying a rate of change for attenuation and passthrough gain during the transition. In some embodiments, the first range of frequencies, the second range of frequencies, and the third range of frequencies are different frequency ranges.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

Various embodiments in accordance with the present disclosure will be described with reference to the drawings, in which:

FIG. 1 illustrates a front perspective view of the audio device showing the physical design and control interfaces, according to certain embodiments of the present disclosure;

FIG. 2 illustrates a side perspective view of the left side of the headset, according to certain embodiments of the present disclosure;

FIG. 3 illustrates an alternative side perspective view of the right side of the headset, according to certain embodiments of the present disclosure;

FIG. 4A illustrates a user interface for setting goals and managing a timer feature on the headset, according to certain embodiments of the present disclosure;

FIG. 4B illustrates a display of usage metrics and device connectivity information, including session trends, noise exposure levels, and connected devices, according to certain embodiments of the present disclosure;

FIG. 4C illustrates an interface for viewing and adjusting connected audio device, and other connected devices, according to certain embodiments of the present disclosure;

FIG. 4D illustrates a graphical interface for modifying device settings for a connected audio device with world volume functionality enabled, according to certain embodiments of the present disclosure;

FIG. 5 illustrates a frequency response chart showing bass, mid-range, and treble ranges, and their potential adjustments using equalization settings, according to certain embodiments of the present disclosure;

FIG. 6 illustrates a dial for adjusting an isolation interface, according to certain embodiments of the present disclosure;

FIG. 7 illustrates a graphical representation of a configuration of multiple modifications to audio, showing variations in sound pressure level performance across different frequency ranges, and creating a flat audio response or baseline “world volume,” according to certain embodiments of the present disclosure;

FIG. 8 illustrates a graphical representation of a bandpass filter configuration used to tailor audio output based on user preferences for different frequency ranges such as voice along with other passthrough arrangements, according to certain embodiments of the present disclosure;

FIG. 9 illustrates a graphical representation of certain passthrough modes, showing the effects of different levels of passthrough gain on sound pressure level and frequency response, according to certain embodiments of the present disclosure;

FIG. 10 illustrates a graphical representation showing an exemplary implementation for how “world volume” may be combined into a single control, according to certain embodiments of the present disclosure;

FIG. 11 illustrates a graphical representation showing an alternative implementation for how “world volume” may be combined into a single control, according to certain embodiments of the present disclosure;

FIG. 12 illustrates a graphical representation showing another alternative implementation for how “world volume” may be combined into a single control, according to certain embodiments of the present disclosure; and

FIG. 13 illustrates a flowchart representing steps in a method for managing audio output in an audio device, according to certain embodiments of the present disclosure.

### DETAILED DESCRIPTION

In the following description, various embodiments of the present invention are described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

The present specification describes audio devices, specifically headsets with advanced sound control features that enable users to adjust the volume of ambient sounds seamlessly, catering particularly to individuals with neurodivergence or sensitivity to auditory stimuli. In certain embodiments, the headsets disclosed herein can help neurotypical individuals engage in deeper focus.

The present disclosure introduces a headset designed to provide users with a seamless and intuitive method of managing ambient sound levels through a concept known as “world volume” control. Unlike traditional headsets that offer limited and often abrupt transitions between discrete modes—such as Active Noise Cancellation (ANC) on/off or transparency mode—the proposed headset can integrate ANC, Passive Noise Control (PNC), and transparency features in a unified system. This integration may allow for smooth, continuous adjustments of ambient sound, resulting in a balanced and natural listening experience across the entire frequency spectrum.

In certain embodiments, this disclosure can address the shortcomings of existing audio devices, particularly the cognitive discomfort users experience due to uneven frequency attenuation when switching between modes. Some ANC technology primarily attenuates low-frequency sounds, while PNC may affect higher frequencies. This disparity can lead to spectral imbalances, causing unnatural sound experiences that can be jarring or uncomfortable for users. Such issues can be especially pronounced for individuals with neurodivergence or heightened sensitivity to auditory stimuli, who may require a more nuanced approach to sound management to maintain focus or reduce sensory overload.

To overcome these challenges, certain embodiments of the described audio device may employ a world volume control interface—such as a dial or slider—that allows users to adjust the level of ambient sound in a manner similar to adjusting the volume of audio content. This control mechanism can simultaneously modulate the ANC and transparency levels while compensating for the inherent effects of PNC, effectively maintaining a flat frequency response throughout the adjustment process. As a result, users can increase or decrease ambient sound levels smoothly without experiencing abrupt changes or frequency imbalances, leading to a more natural and comfortable auditory experience.

The integration of these sound management technologies into a single, user-friendly control interface can significantly simplify the user experience. By consolidating multiple functions into one intuitive control, the audio device may eliminate the need for complex settings or multiple buttons, making it accessible to a wide range of users, including children and individuals with cognitive or sensory processing differences. The simplicity of the world volume control can aid even those unfamiliar with technical audio concepts like ANC or transparency modes in personalizing their listening environment to suit their needs.

In addition to the primary sound management features, the described audio device may incorporate visual indicators—such as LED lights—that reflect the user's current world volume settings and, by extension, their focus or engagement state. For example, certain colors or lighting patterns may indicate that the user is in a highly focused mode with minimal ambient sound, signaling to others that they prefer not to be disturbed. Conversely, different indicators may show that the user is more open to interaction. This feature can be particularly beneficial in environments like classrooms, offices, or collaborative workspaces, where understanding and respecting an individual's focus level can enhance communication and productivity.

The disclosure also contemplates potential expansions of its core technology, such as selective sound filtering capabilities. Users may have the option to customize their sound profiles to allow specific sounds—like emergency sirens, alarms, or a person's name—to bypass attenuation. In certain embodiments, this feature may enable that personally significant sounds are not missed, even when the user has minimized ambient noise for focus or comfort.

Overall, the described audio device offers a comprehensive solution to ambient sound management by providing a headset that can enhances the auditory experience through balanced and customizable sound attenuation and also may supports the user's cognitive and social needs. The present audio device may benefit a wide array of individuals, from those in educational settings to professionals in dynamic work environments to those in busy, commuter settings, and may ultimately foster improved communication, productivity, and personal well-being.

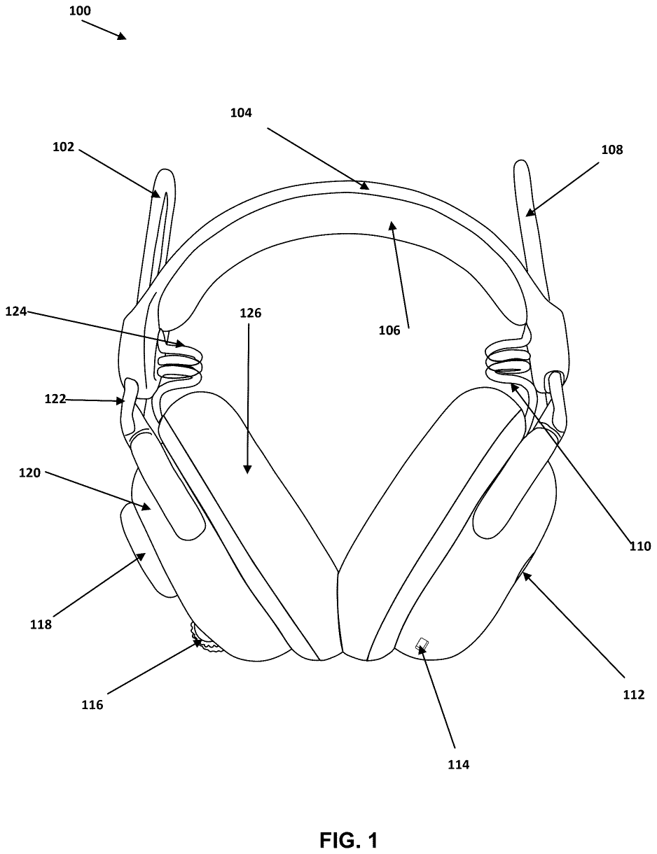

FIG. 1 illustrates a front perspective view of the audio device showing the physical design and control interfaces, according to certain embodiments of the present disclosure. The audio device may include a pair of earphones 100 which may be configured to provide audio output to the user. The earphones may include integrated speakers and may be connected by a headband or another structural element. The pair of earphones may house various internal components, such as microphones, transducers, and electronic circuitry, for performing operations associated with sound processing and user interaction.

The device may include a first antennae 102, which may be positioned on the device and may be configured to perform wireless transmission or reception of signals. The first antennae 102 may also incorporate a microphone on a boom, which may be configured to capture audio for input or communication purposes. In certain embodiments, the antennae may be optimized for various wireless communication protocols, such as Bluetooth, Wi-Fi, Logitech Lightspeed, Logitech Unifying, or the like.

The structural headband 104 may connect the pair of earphones 100 and may provide support and stability for the device during use. The headband may be constructed from materials such as plastic, metal, or composite materials to enable durability and flexibility. The headband may also include adjustable sections to accommodate different head sizes and shapes.

The device may include headband padding 106, which may be positioned along the structural headband 104 to enhance user comfort during extended wear. The padding 106 may be made from a variety of materials, such as memory foam, air pocket structures, feathers, or other cushioning materials. In certain embodiments, the padding may include a hypoallergenic or breathable outer covering to improve ergonomics and reduce irritation during use.

The audio device may include a second antennae 108, which may be configured to perform wireless communication functions similar to the first antennae 102. The second antennae 108 may also include additional features, such as signal amplification or extended frequency range capabilities, depending on the specific embodiment of the device. The antennae may be positioned to optimize signal reception and minimize interference.

The device may include a second wire 110, which may be configured to transmit signals or power between components of the audio device. The second wire 110 may be routed within or along the structural headband 104 to enable a streamlined and unobtrusive design. In certain embodiments, the wire may be shielded to reduce electromagnetic interference and enhance signal integrity.

A first button 112 may be included on the audio device, which may be configured to activate specific features, such as activating a transparency mode.

The audio device may include an input/output (I/O) port 114, which may allow users to establish a wired connection for various purposes. The I/O port 114 may support functions such as playing audio from an external device, charging the audio device's internal battery, or transferring data. In certain embodiments, the port may be configured as a universal USB-C port, a 3.5 mm audio jack, or another standard connection type.

The device may include a scroll wheel 116, which may be configured to control the volume of the audio device. In certain embodiments, the scroll wheel may be used to perform additional functions, such as navigating menus or adjusting audio equalization settings. The scroll wheel 116 may provide tactile feedback to the user, ensuring precise control during operation.

A dial 118 may be included on the audio device, which may be configured to control the world volume or perform other functions. The dial 118 may allow users to adjust the level of ambient sound introduced through passthrough functionality, or it may be configured to modify other audio settings, such as active noise cancellation levels. The dial may include markings or indicators to assist users in selecting their preferred settings.

The audio device may include an ear cup 120, which may incorporate physical controls, passive isolation materials, and integrated speakers. The ear cup 120 may house various electronic circuitry and components required for the operation of the device. The passive isolation materials may include foam or other sound-dampening materials to reduce external noise. The ear cup may also include design features to enhance comfort and usability.

A hinge 122 may connect the ear cup 120 to the structural headband 104, allowing the ear cup to rotate or adjust its position for a better fit. The hinge 122 may be constructed from durable materials, such as metal or reinforced plastic, and may include features to enable smooth and controlled movement. The hinge 122 may also contribute to the portability of the audio device, allowing the ear cups to fold into a compact form for storage or transport. The earphone cup padding 126 may further enhance the seal and comfort provided by the ear cups, ensuring effective noise isolation while accommodating extended periods of wear.

A first wire 124 may be included within the audio device, which may transmit signals or power between components. The first wire 124 may be routed internally within the earphones or headband to streamline the appearance. In certain embodiments, the wire may include shielding to reduce interference and improve performance.

The audio device may include earphone cup padding 126, which may be positioned along the ear cups 120 to enhance comfort during wear. The earphone cup padding 126 may be made from a variety of materials, such as memory foam, air pocket structures, feathers, or other cushioning materials. In certain embodiments, the padding may include a breathable or hypoallergenic covering to reduce irritation and improve user experience. Passive isolation may be facilitated by the ear cups 120, which may include sound-dampening materials such as foam, rubber, or other acoustic insulation materials. These materials may attenuate high-frequency sounds from the surrounding environment and may be integrated into the earphone cup padding 126, which may provide additional comfort to the user. The padding 126 may also contribute to the seal formed between the ear cups and the user's ears, enhancing passive noise isolation.

In certain embodiments, electronics may be distributed across various parts of the audio device. Microphones, which may be located on the outer surfaces of the ear cups 120, or integrated into other parts of the audio device, may detect ambient sounds from the environment. These microphones may capture sound waves and convert them into electrical signals for further processing by the device's passthrough circuitry. The passthrough circuitry, which may be housed within the ear cups 120, may include analog-to-digital converters, amplifiers, and filters to process the captured audio signals. The processed signals may then be routed to the speakers within the ear cups, where they are converted back into sound waves to be output to the user.

Active noise cancellation may be performed by circuitry, which may be located within the ear cups 120. This circuitry may include digital signal processors (DSPs) that analyze ambient noise captured by microphones and generate anti-noise signals to counteract specific frequencies, particularly in the low-frequency range. The generated anti-noise signals may be combined with audio signals from passthrough functionality or other sources and then output through the speakers. The active noise cancellation circuitry may be designed to work in conjunction with the passive isolation materials to provide comprehensive noise reduction across a wide range of frequencies.

The signal input elements, which may include the scroll wheel 116, dial 118, and first button 112, may allow the user to configure the combination schema that blends frequencies attenuated by passive isolation, active noise cancellation, and passthrough functionality. The scroll wheel 116 may be used to adjust the overall system volume, while the dial 118 may allow the user to control the world volume or adjust the level of ambient sound introduced via passthrough. The first button 112 may activate specific features, such as enabling a transparency mode. In certain embodiments, any of these functionalities may be done by any of these components. In certain other embodiments, the audio characteristics may be customized by data coming in the I/O port 114. The I/O port 114 may support wired connections for charging the device, playing audio from external sources, or transferring data besides the data used to customize the audio. In certain embodiments, the port may facilitate firmware updates or advanced configuration of the device's internal settings. Visual indicators, such as LEDs integrated into the ear cups 120 or other parts of the device, may provide feedback on the active noise cancellation levels, passthrough settings, or system volume, ensuring the user is informed of the device's current configuration.

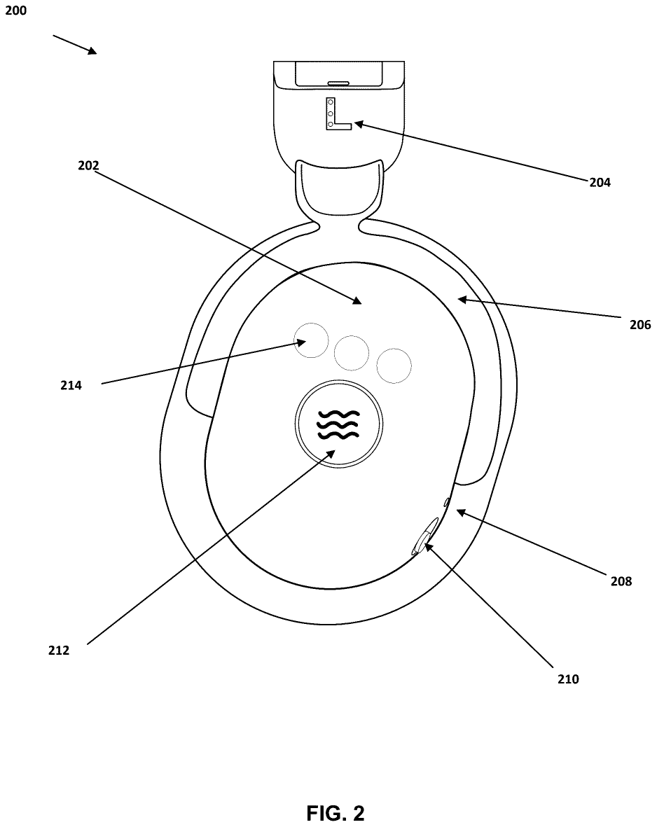

FIG. 2 illustrates a side perspective view of the left side of the headset, according to certain embodiments of the present disclosure. The depicted left earcup 200 may include various components configured to support audio playback, user interaction, and device functionality. The left earcup 200 may represent one embodiment of the audio device described, with specific design features and arrangements that can vary depending on other configurations.

The outside of the earcup 202 may form part of the external shell of the left earphone and may be designed to protect internal components, such as speakers, microphones, and electronic circuitry, from physical damage or environmental exposure. The outside of the earcup 202 may also contribute to the aesthetic design of the headset, with options for materials such as plastic, metal, composite materials, or combinations thereof. In certain embodiments, the outside of the earcup 202 may include additional design elements, such as textured surfaces or branding.

The L indicator 204 may be positioned on the exterior or interior of the earcup 202 to indicate that the depicted earphone corresponds to the left side of the headset. The L indicator 204 may be implemented in various ways, such as engraved text, printed markings, or raised symbols. In certain embodiments, the indicator may be illuminated or designed with contrasting colors to improve visibility for the user. The L indicator 204 may also assist users in correctly positioning the headset during wear.

The hinge 206 may connect the earcup 202 to the structural headband and may allow the earcup to rotate or pivot for improved fit and comfort. The hinge 206 may be constructed from durable materials, such as metal, reinforced plastic, or composite materials, and may be designed to withstand repeated adjustments over time. In certain embodiments, the hinge 206 may include features such as locking mechanisms to ensure stability or smooth rotation during use. The hinge may also contribute to the portability of the headset, allowing the earcup to fold into a compact form for storage or transport.

The LED indicator 208 may be positioned on the outside of the earcup 202 and may be configured to display the operational status of the headset. For example, the LED indicator 208 may illuminate when the headset is powered on or connected to a wireless network and may turn off when the headset is powered down. In certain embodiments, the LED indicator 208 may blink or change color to indicate battery level, pairing status, or other device states. The design, arrangement, and functionality of the LED indicator 208 may vary depending on the specific embodiment.

The mechanical switch 210 may be positioned on the outside of the earcup 202 and may be configured to perform various functions, such as powering the headset on or off, toggling between audio modes, or activating specific device features. The mechanical switch 210 may include tactile feedback to ensure precise control during operation and may be designed to operate reliably under repeated use. In certain embodiments, the switch may include markings or indicators to assist the user in identifying its current position or function.

The side button 212 may be positioned on the outside of the earcup 202 and may be configured to activate specific features of the headset. For example, the side button 212 may enable passthrough functionality, allowing ambient sounds to be introduced into the audio output, or it may activate calming noises, such as white noise or nature sounds. In other embodiments, the side button 212 may be configured to adjust audio settings, such as volume, equalization, or active noise cancellation. The placement, design, and functionality of the side button 212 may vary depending on the specific embodiment.

The LED indicator 214 on the side panel of the earcup 202 may be positioned adjacent to the side button 212 and may be configured to display the level of “focus” of the user. For example, the LED indicator 214 may illuminate or change color to represent the user's current engagement with a focus-enhancing feature, such as active noise cancellation or calming sounds. In one embodiment, the world volume is minimized when all of the LED lights comprising the world volume indicator are on, and proportionally fewer LEDs may be displayed for a proportionally louder world volume. In certain embodiments, the LED indicator 214 may be arranged differently, such as being positioned elsewhere on the earcup, positioned around a dial controlling the world volume, created as a world volume array that is filled as the world volume increases, or is omitted entirely. The design, arrangement, and functionality of the LED indicator 214 may vary depending on the specific embodiment and intended use case.

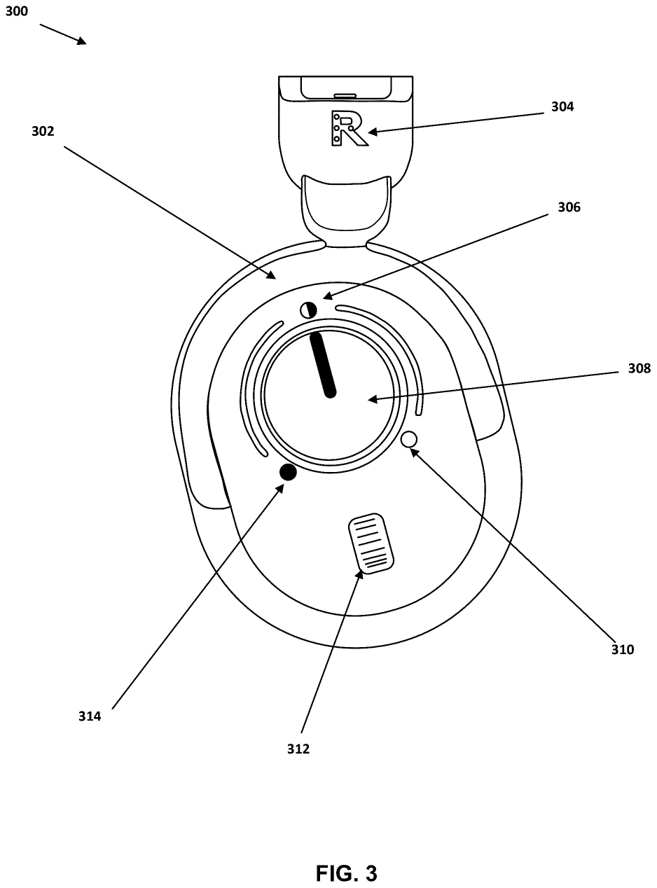

FIG. 3 illustrates an alternative side perspective view of the right side of the headset, according to certain embodiments of the present disclosure. The depicted headset may include various components configured to support audio playback, user interaction, and device functionality specific to the right earphone. These components may be arranged differently based on the embodiment, providing flexibility in design and functionality. In certain embodiments, the functionalities may be switched with the left earcup 200, or the individual components or features can be mixed and matched.

The right earcup 300 may form the external shell of the right earphone and may be designed to protect internal components, such as speakers, microphones, and electronic circuitry. The right earcup 300 may also contribute to the aesthetic design of the headset, with options for materials. In certain embodiments, the right earcup 300 may include additional design elements, such as textured surfaces, branding, or visual indicators.

The right hinge 302 may connect the right earcup 300 to the structural headband and may allow the earcup to rotate or pivot for improved fit and comfort. The right hinge 302 may be constructed from durable materials to withstand repeated adjustments over time. In certain embodiments, the hinge 302 may include features such as locking mechanisms to ensure stability or smooth rotation during use. The hinge may also facilitate portability.

The R indicator 304 may be positioned on the exterior or interior of the right earcup 300 to indicate that the depicted earphone corresponds to the right side of the headset. The R indicator 304 may be implemented in various ways, such as engraved text, printed markings, or raised symbols. In some embodiments, the indicator may be illuminated or designed with contrasting colors to improve visibility for the user. The R indicator 304 may assist users in correctly positioning the headset during wear.

The top dial indicator 306 may be positioned adjacent to the dial 308 on the right earcup 300 and may be configured to provide feedback about the current setting of the dial. The top dial indicator 306 may illuminate or change color to represent specific settings, such as volume level, passthrough gain, or noise cancellation intensity. In certain embodiments, the top dial indicator 306 may include markings or numerical values to further assist the user in identifying the dial's current position.

The dial 308 may be included on the right earcup 300 and may be configured to control various settings, such as the world volume or passthrough levels. The dial 308 may allow users to adjust the amount of ambient sound introduced into the audio output or modify other audio parameters, such as noise cancellation intensity or equalization profiles. The dial may include tactile feedback, markings, or indicators such as minimized dial indicator 314, top dial indicator 306, or maxed dial indicator 310 to assist users in selecting their preferred settings. In certain embodiments, the dial 308 may be designed to perform additional functions or may be omitted entirely.

The maxed dial indicator 310 may be positioned adjacent to the dial 308 and may be configured to provide visual feedback when the dial is turned to its maximum setting. The maxed dial indicator 310 may illuminate or display a specific color to indicate that the highest level of the selected setting has been reached. In certain embodiments, the maxed dial indicator 310 may also provide feedback through blinking patterns or other visual cues. The minimized dial indicator 314 may be positioned adjacent to the dial 308 and may provide visual feedback when the dial is turned to its minimum setting. The minimized dial indicator 314 may illuminate or display a specific color to indicate that the lowest level of the selected setting has been reached. In certain embodiments, the minimized dial indicator 314 may also provide feedback through blinking patterns or other visual cues, assisting users in understanding the current configuration of the device.

The side dial 312 may be included on the right earcup 300 and may be configured to control additional settings, such as world volume, device volume (e.g. volume of music played through earcup speakers), passthrough gain, active noise cancellation levels, or specific equalization profiles. The side dial 312 may allow users to make fine adjustments to the device's audio output or environmental interaction. The design and placement of the side dial 312 may vary depending on the embodiment, and in certain configurations, the side dial may perform additional functions or be omitted entirely.

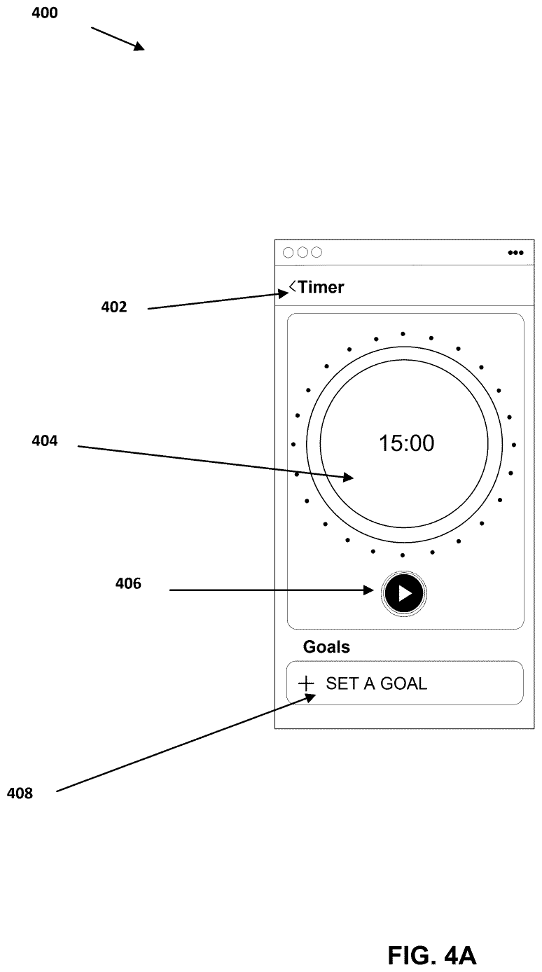

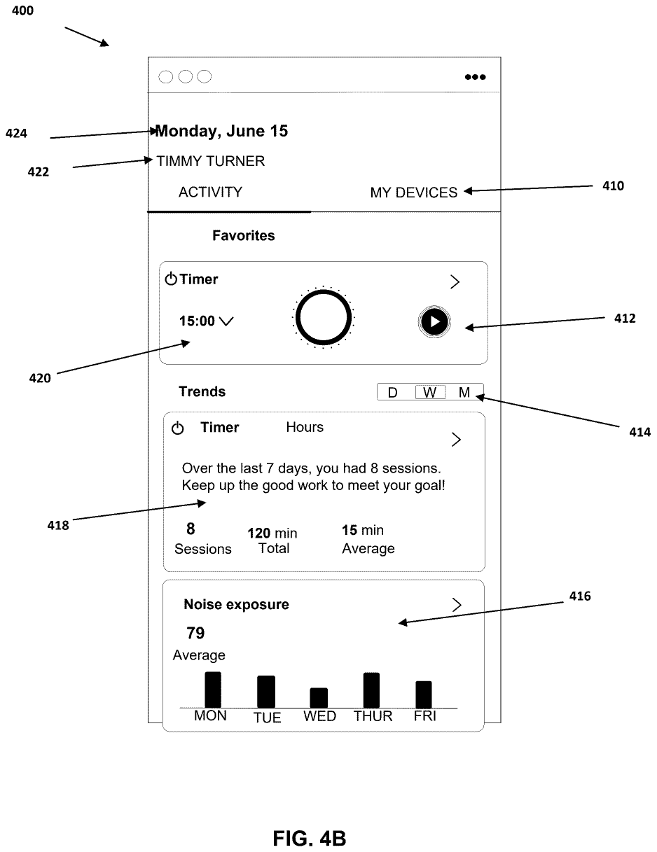

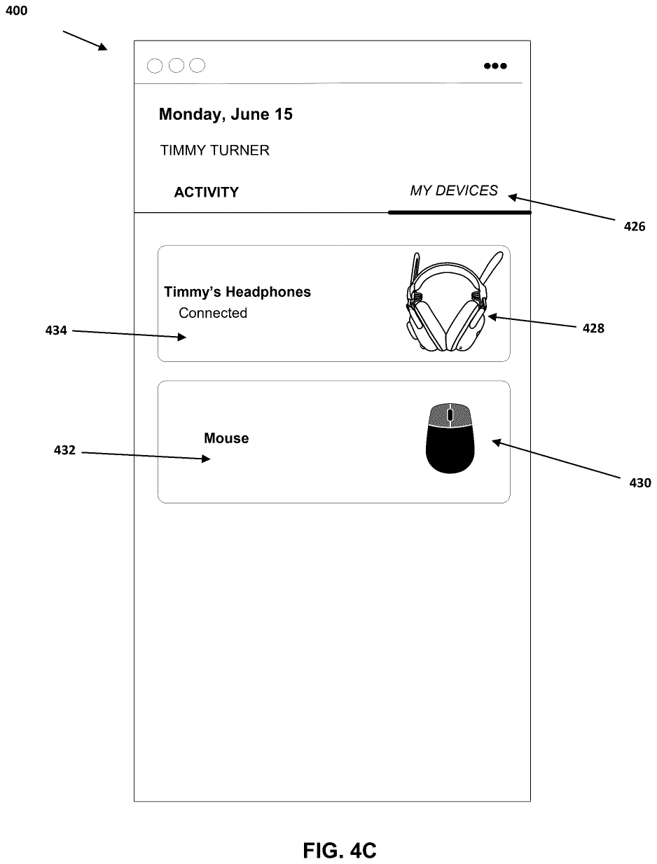

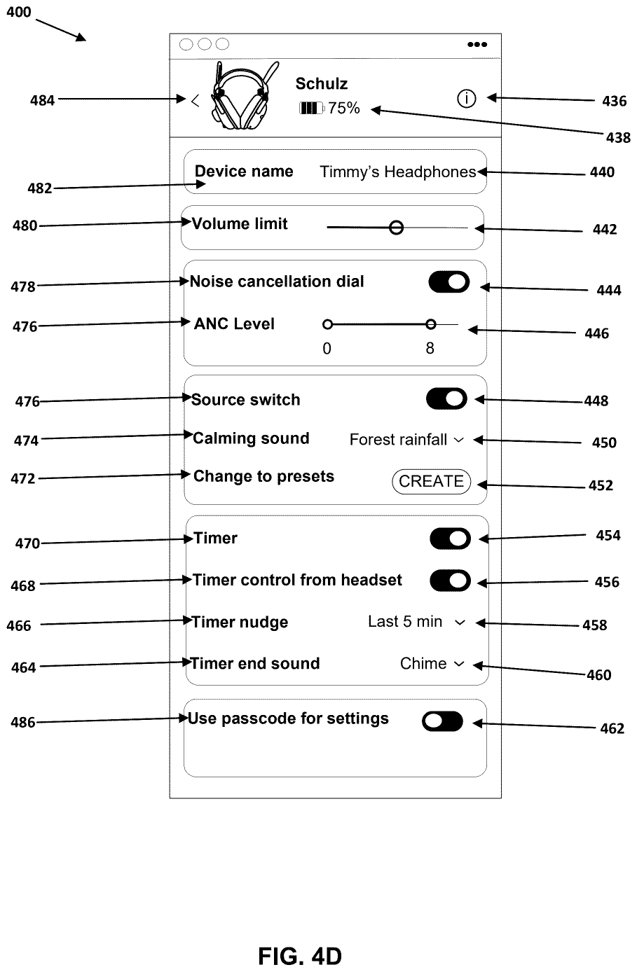

FIG. 4A illustrates a user interface for setting goals and managing a timer feature on the headset, according to certain embodiments of the present disclosure. The user interface may be displayed on a screen or integrated into an external device, such as a smartphone, tablet, or computer, that communicates with the headset. Alternatively, the user interface may be configured to operate directly on the headset via physical controls, such as buttons, dials, or touch-sensitive panels. The configuration and design of the user interface may vary depending on the embodiment, providing flexibility for different use cases.

The user interface may include a timer feature 402 that allows users to set a specific duration for activities or focus sessions. The timer 404 may be displayed numerically, such as “15:00,” representing minutes and seconds. In certain embodiments, the timer 404 may include options for customization, such as setting the duration to predefined intervals or manually inputting a desired time. The timer functionality may support various modes, such as countdown timers, stopwatch features, or reminders, depending on the user's preferences.

The user interface may also include a goal-setting feature 408 that enables users to define specific objectives or tasks to complete during the timer session. Goals may be displayed as text, icons, or other graphical elements, and the user interface may allow users to select or customize goals from a list of predefined options. For example, the goals may include focus-oriented tasks, such as studying, meditation, or work-related activities, or physical tasks, such as exercise or relaxation. In certain embodiments, the goal-setting feature may include progress tracking or visual indicators to show completion status.

The user interface may include interactive controls 406 for managing the timer and goals. These controls 406 may include touch-sensitive areas, buttons, or sliders that allow users to start, pause, reset, or adjust the timer. In certain embodiments, the user interface may incorporate gestures, voice commands, or integrated controls on the headset to operate the timer and goal-setting features. The design and placement of these controls may vary based on the embodiment, ensuring ease of use and accessibility.

The user interface may provide visual feedback to indicate the timer's status or progress toward the defined goals. For example, graphical elements such as progress bars, countdown animations, or color changes may be displayed to represent the remaining time or completion percentage. In certain embodiments, the visual feedback may be accompanied by auditory cues, such as beeps, chimes, or spoken notifications, to alert the user when the timer ends or when a goal is achieved.

In some embodiments, the user interface may be configurable to include additional features. For example, the timer may be linked to calming sounds or focus-enhancing audio content that plays automatically during the session. Users may also be able to integrate the timer and goal-setting features with third-party applications or devices, such as productivity apps, calendars, or fitness trackers, to synchronize activities and track progress over time.

The design of the user interface may prioritize simplicity and user-friendliness, allowing users to quickly set and manage timers and goals without requiring extensive setup. The layout and graphical elements may be customizable to suit different user preferences or accessibility needs. For example, font sizes, colors, or themes may be adjustable to improve visibility or align with the user's aesthetic preferences.

The components and features described above may be arranged in various configurations depending on the embodiment of the user interface. These configurations may provide flexibility in design while ensuring that the timer and goal-setting functionalities are fully supported for different use cases and user needs.

FIG. 4B illustrates a display of usage metrics and device connectivity information, including session trends, noise exposure levels, and connected devices, according to certain embodiments of the present disclosure. The display 400 may be configured to provide visual feedback to the user regarding their interaction with the headset and its associated features. The display 400 may be implemented on an external device, such as a smartphone, tablet, or computer, or may be integrated directly into the headset if the device includes a built-in screen. In certain embodiments, the display may communicate with the headset wirelessly via Bluetooth, Wi-Fi, or another protocol, or through a wired connection such as USB or another I/O port.

The display 400 may include a date field 424, which may be positioned prominently on the screen to indicate the current date. The date field 424 may be presented in various formats, including but not limited to “Monday, June 15” or alternative regional formats such as “15 Jun. 2025.” The date field 424 may update dynamically based on the user's time zone or system configuration settings. In some embodiments, the date field 424 may be customizable, allowing the user to modify its appearance, format, or additional contextual information, such as reminders or calendar events.

The user's name 422 may be displayed on the screen as part of the display 400. The user's name 422 may be linked to an account or profile associated with the device or stored locally on the external device or headset. In some embodiments, the user's name may be presented as editable text, allowing the user to personalize the display. The name 422 may also be used for identification purposes in multi-user environments or integrated into other features, such as personalized recommendations or analytics.

A UI element 410 may be positioned on the display 400 to allow the user to toggle to a screen labeled “My Devices.” This UI element 410 may be implemented as a button, icon, tab, or other interactive element. Selecting this UI element 410 may provide access to information about connected devices, such as smartphones, computers, or other audio equipment. In certain embodiments, the “My Devices” screen may include options for adding new devices, disconnecting existing devices, or configuring device-specific settings. The UI element 410 may include visual indicators, such as icons or animations, to show the current connection status or available devices.

The timer feature 420 may be displayed as a minimized widget to conserve screen real estate. The minimized timer widget may show essential information, such as the remaining time in a countdown format, without occupying significant space on the display. The timer widget may allow users to start, stop, or reset the timer directly from the minimized view. In certain embodiments, selecting the timer widget may expand it into a full-screen view, providing additional functionality, such as custom duration settings, alarms, or linked activities. The timer feature 420 may also interact with other components of the display, such as session analytics or goal-setting features.

The performance report 418 and session analytics widget may provide insights into the user's interaction with the headset over time. This widget may display metrics such as the number of completed sessions, average session duration, cumulative usage time, or focus levels during specific activities. The performance report 418 may include graphical elements, such as charts, graphs, or trend lines, to represent usage patterns and progress. In certain embodiments, the analytics widget may be customizable, allowing users to select specific metrics or timeframes for analysis. The performance report 418 may also integrate with goal-setting features, enabling users to track progress toward defined objectives.

The noise exposure widget 416 may provide feedback regarding the user's exposure to ambient noise while using the headset. This widget may display metrics such as average noise levels, peak noise exposure, or cumulative exposure over time. In certain embodiments, the noise exposure widget 416 may include recommendations or alerts to inform the user if their exposure exceeds safe thresholds. The noise exposure data may be collected by the microphones on the headset and processed by internal circuitry to ensure accuracy. The widget may also include interactive elements, such as toggles or sliders, to enable the user to adjust sensitivity or reporting settings.

The display 400 may be designed to prioritize usability and readability, ensuring that users can quickly access and interpret the information provided. The layout of the widgets and UI elements may be customizable, allowing users to rearrange, resize, or hide specific components based on their preferences. For example, a user may prefer to emphasize session analytics over noise exposure or minimize certain widgets to declutter the interface.

In certain embodiments, the display 400 may include additional features that enhance functionality or interactivity. For example, widgets may support touch gestures, voice commands, or integration with external applications to provide extended capabilities. Users may also be able to export or share data, such as session analytics or noise exposure reports, through third-party platforms or productivity tools. The display may include dynamic elements, such as animations or color changes, to provide visual feedback about system status or user actions. The components and features described above may be arranged in various configurations depending on the embodiment of the display 400.

FIG. 4C illustrates an interface for viewing and adjusting audio and other connected devices, according to certain embodiments of the present disclosure. The interface may be displayed on an external device, such as a smartphone, tablet, or computer, or may operate directly on the headset if the device includes a built-in screen. The interface may allow users to manage connected devices, view device-specific information, and adjust settings for each device. The arrangement and functionality of the interface may vary depending on the embodiment, providing flexibility for different use cases.

The selection of “My Devices” 426 may indicate that the user has chosen to access the device management screen. This selection may be made via a UI element, such as a button, tab, or icon, that allows users to toggle between different sections of the interface. The “My Devices” section may display a list of devices currently paired or connected to the headset, along with options to manage these connections. In certain embodiments, the user may be able to navigate back to other sections of the interface, such as usage metrics or timer features, by selecting alternative UI elements.

The headphone widget 434 may provide detailed information about the headset itself as one of the connected devices. This widget may include options for viewing the headset's current status, such as battery level, active noise cancellation mode, passthrough settings, or other operational metrics. The headphone widget 434 may also allow users to adjust specific settings, such as volume, equalization, or connection preferences. In certain embodiments, the widget may include interactive controls, such as sliders, buttons, or toggles, to enable direct adjustments.

A visual depiction 428 of the coupled device may be included within the headphone widget 434 to visually represent the headset. This visual depiction may be a stylized image or icon of the headset, allowing users to quickly identify the device within the interface. In some embodiments, the visual depiction 428 may update dynamically to reflect changes in the device's status, such as battery level or connection state. The depiction may also include additional visual elements, such as color changes or animations, to enhance usability and feedback.

An alternative device name 432 may be displayed within the interface to represent another connected device. This name may correspond to a device paired with the headset, such as a mouse, another pair of headphones, a computer peripheral, or any other compatible device. The name 432 may be customizable, allowing users to rename devices according to their preferences. In certain embodiments, the alternative device name may include additional information, such as the device's model, manufacturer, or current status.

A visual depiction of another device 430 may be included alongside the alternative device name 432. This visual depiction of another device 430 may visually represent the connected device, providing a clear and recognizable image or icon for the user. For example, the depiction may show a mouse, another pair of headphones, or a different computer peripheral. In certain embodiments, the visual depiction of another device 430 may update dynamically to reflect the device's current status, such as battery level, connection state, or operational mode. The depiction may also include interactive elements, such as buttons or sliders, to allow users to adjust device-specific settings directly from the interface.

The interface may allow users to perform various actions related to connected devices, such as adding new devices, removing existing connections, or configuring device-specific settings. For example, users may be able to initiate pairing processes, select preferred audio output devices, or adjust connection priorities. In certain embodiments, the interface may include options for troubleshooting connectivity issues or providing recommendations for optimizing device performance.

The design of the interface may prioritize usability and readability, ensuring that users can quickly access and interpret the information provided. The layout of the widgets and UI elements may be customizable, allowing users to rearrange, resize, or hide specific components based on their preferences. For example, a user may prefer to emphasize the headphone widget 434 over the alternative device name 432 or minimize certain graphical depictions to declutter the interface.

FIG. 4D illustrates a graphical interface for modifying device settings for a connected audio device, according to certain embodiments of the present disclosure. The graphical interface may allow users to adjust various settings, including audio parameters, noise cancellation levels, calming sounds, and timer functionality. The design and arrangement of the graphical interface may vary depending on the embodiment, providing flexibility for different use cases and user preferences. Each labeled callout represents a unique element or control that may be displayed on the screen.

The device graphical representation 484 may provide a visual depiction of the connected audio device, allowing users to quickly identify the device being controlled. The graphical representation may be a stylized image or icon of the device, such as a headset, and may dynamically update to reflect the device's current state, such as power status or connection mode.

The battery status indicator 438 may display the remaining battery life of the connected device. The indicator may be shown as a percentage, graphical bar, or icon, and may include additional visual elements, such as color changes, to indicate low battery levels or charging status. In certain embodiments, the battery status indicator 438 may provide alerts or notifications when the battery reaches critical levels.

The information button 436 may provide access to additional details or settings related to the connected audio device. When selected, the information button 436 may display a pop-up window or navigate to a separate screen where users can view device specifications, firmware version, or troubleshooting options. The design and placement of the button may vary depending on the embodiment.

The device name label 482 may display a textual identifier for the connected device. In this embodiment, the device name field 440 is displayed as “Timmy's Headphones.” The label may allow users to rename the device for personalization or clarity, especially in environments with multiple connected devices. In certain embodiments, the device name label 484 may be linked to device-specific settings or controls.

The volume limit label 480 may indicate the section of the interface where users can adjust the maximum volume output of the audio device. This label may help users locate the corresponding control and may include descriptive text or icons. The volume limit slider 442 may allow users to set a maximum volume level for the device. The slider may include a continuous or discrete range of values, enabling precise adjustments. In certain embodiments, the slider may include safety features, such as warnings when the volume exceeds safe listening levels. In other embodiments, it may be a dropdown or any other means for entering a volume into the system.

The noise cancellation dial label 478 may identify the section of the interface where users can adjust noise cancellation settings. The label may include text or icons to describe its functionality. The noise cancellation toggle 444 may allow users to enable or disable noise cancellation features. When active, the toggle may display a highlighted or activated state, and when inactive, it may revert to a neutral or grayed-out appearance.

The ANC level label 476 may indicate the section of the interface dedicated to controlling the intensity of active noise cancellation. The corresponding ANC level slider 446 may allow users to adjust the noise cancellation level within a discrete range of values, such as from 0 to 10. In certain embodiments, the slider may include visual cues, such as color gradients or numerical markers, to represent the selected level.

The source switch label 476 may identify the section of the interface for selecting or toggling between audio sources. The source switch toggle 448 may allow users to choose between different connected devices or audio inputs. For example, the toggle may enable switching between a smartphone, computer, or other audio source.

The calming sound label 474 may indicate the section of the interface where users can select pre-configured calming sounds for playback. The calming sound dropdown 450 may provide a list of available sounds, such as “forest rainfall,” “white noise,” or “ocean waves.” In this embodiment, the dropdown is currently set to “forest rainfall.” Users may select a different sound from the dropdown to personalize their experience.

The change to presets label 472 may identify the section of the interface for managing or modifying preset audio configurations. The create button 452 may allow users to create new presets by saving specific combinations of settings, such as volume levels, noise cancellation intensity, and passthrough functionality. In certain embodiments, the button may also allow users to edit or delete existing presets.

The timer label 470 may indicate the section of the interface for managing the timer feature. The timer toggle 454 may allow users to enable or disable the timer functionality. When enabled, the toggle may activate additional controls for setting and managing the timer. The timer control from headset label 468 may indicate whether the timer can be directly controlled using physical buttons or dials on the audio device. The timer control toggle 456 may allow users to enable or disable this feature. When enabled, users may start, stop, or adjust the timer directly from the headset without accessing the graphical interface. The timer nudge label 466 may identify a feature for adjusting the timer incrementally. The timer nudge dropdown 458 may provide options for fine-tuning the timer duration, such as “Last 5 min” or other predefined intervals. In this embodiment, the dropdown is set to “Last 5 min,” indicating that the timer will be adjusted by 5-minute increments. The timer end sound label 464 may indicate the section of the interface for selecting the sound played when the timer expires. The timer end sound dropdown 460 may allow users to choose from a list of options, such as “chime,” “beep,” or “alarm.” In this embodiment, the dropdown is currently set to “chime.”

The use passcode for settings label 486 may identify a security feature for protecting the device's settings. The use passcode toggle 462 may allow users to enable or disable this feature. When enabled, users may be required to enter a passcode to access or modify certain settings, enhancing privacy and security.

The components and features described above may be arranged in various configurations depending on the embodiment of the graphical interface. These configurations may provide flexibility in design while ensuring that device settings and world volume functionality are supported for different use cases and user preferences.

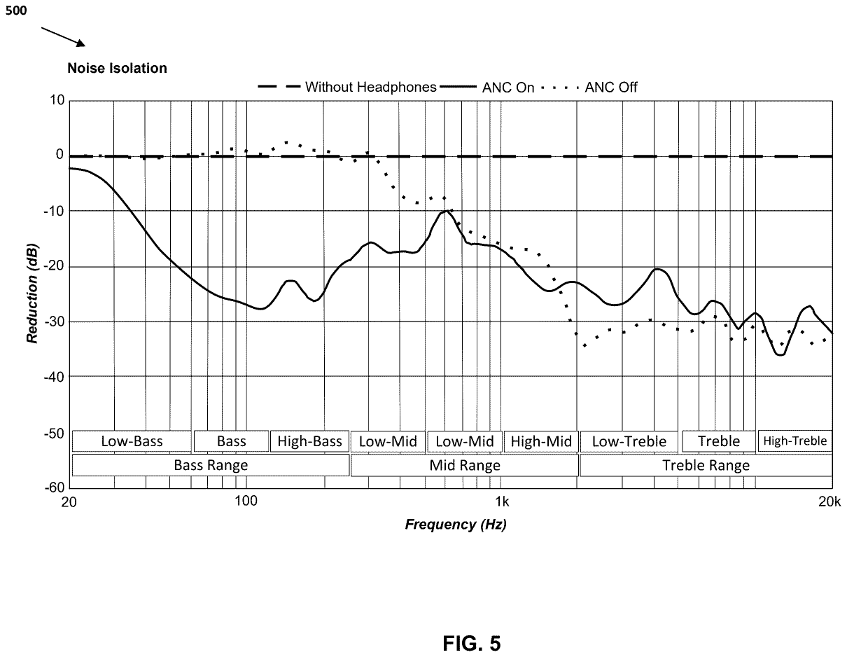

FIG. 5 illustrates a graph titled “ANC Headset Frequency Response,” which represents the frequency response characteristics of an active noise cancellation (ANC) headset. The graph may provide insights into how the headset attenuates or amplifies different frequency ranges during operation, showcasing ANC's capabilities in managing audio performance and noise isolation.

The graph includes frequency values on the x-axis, which may be labeled in units of Hertz (Hz) to represent different sound frequencies. The frequency range spans from low frequencies, such as 20 Hz, to high frequencies, such as 20,000 Hz (20 kHz), which corresponds to the typical audible range for humans. The y-axis represents sound pressure level (SPL) in decibels (dB), which may indicate the intensity or amplitude of the sound at each frequency. The y-axis may include values that range from a positive decibel level (representing amplified sound) to a negative decibel level (representing attenuated sound).

The graph depicts several curves or lines corresponding to different frequency response characteristics of the ANC headset. These curves represent various operational modes or settings of the headset, such as ANC on, ANC off, and without headphones. Each line illustrates how the headset, or lack thereof interacts with sound frequencies, such as reducing noise at specific ranges or maintaining clarity for desired frequencies.

From the low bass to the low mid, the ANC attenuates sound far more effectively than does a headset without ANC, indicating the headset's ability to cancel out persistent low-frequency noises, such as engine hums, air conditioning, or other background sounds. This performance may be attributed to the ANC circuitry, which generates anti-noise signals to counteract incoming sound waves.

In the mid-frequency range, between approximately 1 kHz and 5 kHz, the graph demonstrates a more moderate level of attenuation or amplification. This region corresponds to sounds that are less effectively canceled by ANC due to the complexity or rapid changes in the sound waves. There is far less to almost no discrepancy between the headset with ANC on and off, although both are lower than the without headphones line.

For high frequencies, typically above 1 kHz, the graph may show little to no attenuation from ANC, as high-frequency sounds are often managed through passive isolation rather than ANC. The curve may remain relatively flat or show slight reductions, depending on the materials and design of the ear cups used in the headset. High-frequency sounds, such as sharp tones or sudden noises, may penetrate the headset less effectively due to the physical barriers provided by the passive isolation materials.

The graph includes labeled regions or markers to highlight specific frequency bands, such as bass, midrange, and treble. These labels may assist users in understanding the headset's performance across different audio ranges, enabling them to tailor settings to their preferences. For example, users may prioritize ANC settings for low-frequency noise cancellation while preserving midrange clarity for conversations or high-frequency detail for music playback.

An insight that can be gleaned from this graph is that adjusting the level of the ANC may only results in changes in the lower frequency response. Even when the ANC is maxed, from the user perspective, the upper frequencies may not change.

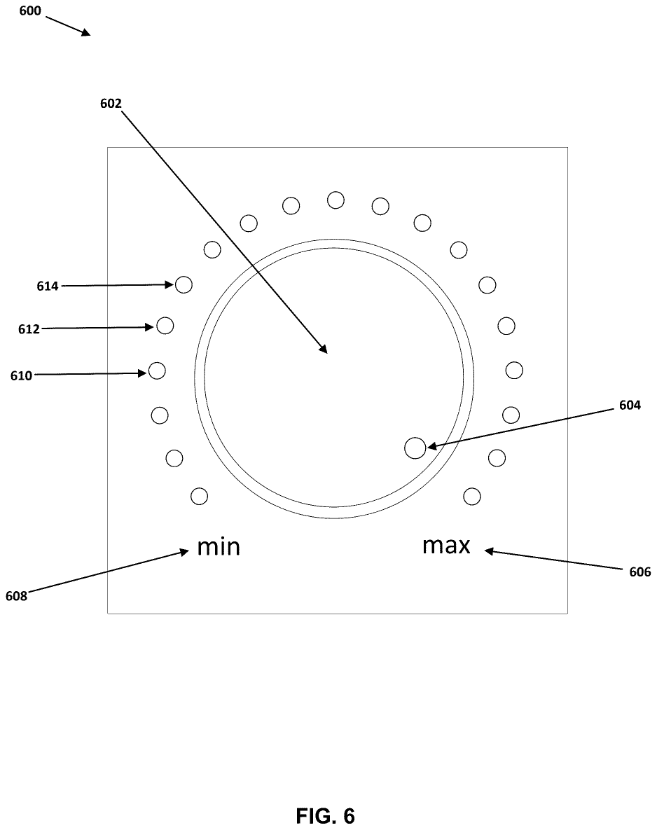

FIG. 6 illustrates a dial for adjusting an isolation interface, according to certain embodiments of the present disclosure. The dial 600 may provide a user-adjustable mechanism to control the balance between ambient environment passthrough and active isolation, allowing users to customize their audio experience based on their preferences and surroundings. The dial 600 may be implemented physically on the headphones, as part of an electronic interface on a connected device, or integrated into a dongle or other accessory. The design and placement of the dial may vary depending on the embodiment, providing flexibility in its implementation.

The dial 600 may represent the entire control mechanism and may be configured to adjust the audio device's passthrough and isolation settings either continuously or discretely. In certain embodiments, the dial may allow users to transition smoothly between ambient passthrough and active isolation modes, enabling precise adjustments to match their desired level of interaction with the surrounding environment. Alternatively, the dial may include predefined steps or discrete positions for specific levels of passthrough or isolation, simplifying user interaction.

The minimum setting 608 may correspond to maximized ambient environment passthrough, allowing external sounds to be introduced into the audio device's output with minimal attenuation. At this setting, the microphones on the audio device may capture ambient sounds and transmit them directly to the user, providing a natural listening experience similar to not wearing headphones. This mode may be particularly useful in situations where users need to remain aware of their surroundings, such as during conversations or in safety-critical environments.

The maximum setting 606 may correspond to maximized isolation, combining active noise cancellation (ANC) and passive attenuation to block out external sounds. At this setting, the audio device may prioritize reducing ambient noise, using ANC circuitry to cancel low-frequency sounds and passive isolation materials to attenuate higher frequencies. This mode may be ideal for situations where users require a focused or distraction-free environment, such as during work, study, or relaxation.

The adjustable dial 602 may allow the wearer to select a position between the minimum setting 608 and maximum setting 606, providing control over the level of passthrough and isolation. The dial 602 may be configured to operate continuously, enabling users to fine-tune their preferred balance without predefined steps. Alternatively, the dial may include discrete positions or clicks, representing specific levels of passthrough or isolation. In certain embodiments, the dial 602 may include tactile feedback, such as resistance or detents, to assist users in identifying their selected position.

The current position indicator 604 may display the dial's active setting, providing visual feedback about the selected level of passthrough or isolation. In this depiction, the current position is set to the maximum isolation setting 606, as shown in FIG. 6. The indicator 604 may update dynamically as the user adjusts the dial, ensuring real-time feedback about the device's configuration.

The level indicators 610, 612, and 614 may provide additional visual cues about the dial's position. These indicators may be positioned along the circumference of the dial or adjacent to it and may represent different levels of passthrough or isolation. In certain embodiments, the level indicators may be implemented as LEDs, lighting up sequentially or changing color to represent the selected setting. For example, a green light may indicate maximized passthrough, while a red light may represent maximized isolation. Alternatively, the indicators may use other mechanisms, such as graphical elements on a digital interface or mechanical markers, to convey information about the dial's position.

In certain embodiments, the audio device may include a transitional mode designed to provide a smooth transition between audio states, such as maximum isolation and maximum passthrough. This mode may be useful in situations where abrupt changes in audio settings could cause discomfort or disrupt the user's auditory experience. By blending attenuation levels from passive isolation, active noise cancellation, and passthrough gain over a configurable time period, the transitional mode ensures a gradual and natural adjustment.

The transitional mode may be triggered by various inputs, such as user interaction with physical controls (e.g., dials, sliders, or buttons), commands from a connected external device, or environmental changes detected by microphones integrated into the audio device. For example, the transitional mode may activate automatically when the device detects a shift in ambient noise levels exceeding a predefined threshold or when a user manually adjusts the world volume control to a predefined position.

During the transition, the audio device may balance the contributions of passive isolation, active noise cancellation, and passthrough gain to maintain a consistent frequency response. This balanced response may prevent auditory discomfort caused by abrupt changes in sound pressure levels or spectral imbalances. In some implementations, the transitional mode may prioritize specific frequency ranges, such as human voices, to ensure clarity and situational awareness.

The duration of the transitional mode may be adjustable, allowing users to configure the time period over which the transition occurs. For example, the transition may complete within a range of 1 second to 30 seconds, depending on user preferences or environmental conditions. In some embodiments, the transition may complete in an hour or more. Visual indicators, such as LED arrays integrated into the audio device, may provide feedback on the progression of the transition, displaying the current state and notifying the user when the transition is complete. The transitional mode may be further customized via a combination schema received from a signal input element, such as a physical dial or a graphical interface on a connected device. This schema may specify parameters for blending frequency ranges, adjusting gain levels, and defining the rate of change during the transition.

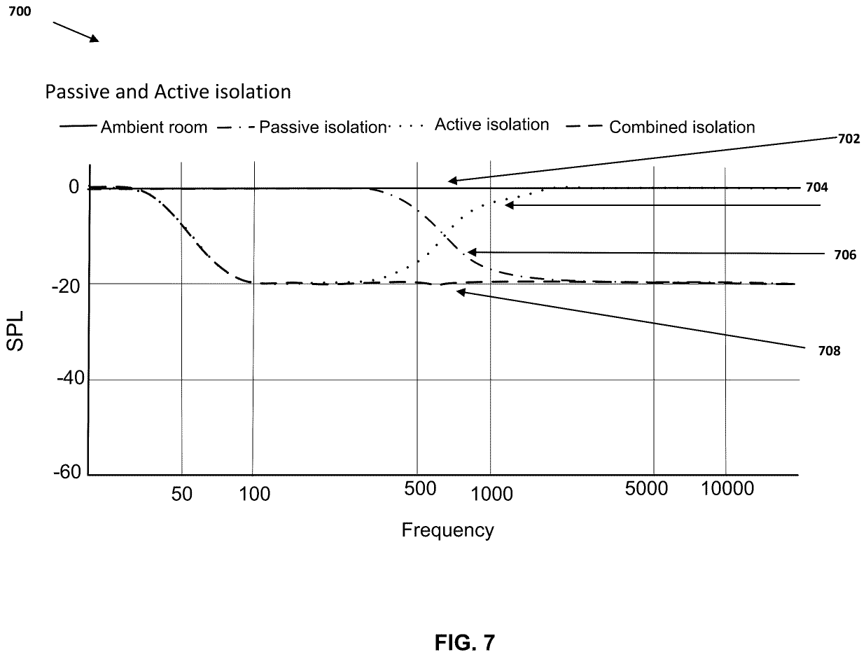

FIG. 7 illustrates a configuration of multiple modifications to audio, showing variations in sound pressure level (SPL) performance across different frequency ranges, and creating a flat audio response or “world volume,” according to certain embodiments of the present disclosure. The graph may depict how passive isolation and active noise cancellation (ANC) work independently and in combination to shape the audio device's frequency response, offering a balanced and comfortable listening experience for the user.

The ambient room line 702 represents the baseline sound pressure level of an unmodified ambient environment. This line may correspond to the natural acoustic conditions experienced by the user without wearing the audio device or enabling any isolation features. The ambient room line 702 may serve as a reference point for comparing the effects of passive isolation, active isolation, and combined isolation on the user's auditory experience.

The passive isolation line 706 illustrates the frequency response resulting from circumaural earpads or other sound-dampening materials integrated into the audio device. Passive isolation may primarily attenuate upper frequencies, as higher-frequency sounds are more effectively blocked by physical barriers, such as foam, fabric, or other acoustic insulation materials. The passive isolation line 706 may demonstrate a gradual reduction in SPL at higher frequencies, while lower frequencies remain relatively unaffected due to the limitations of physical attenuation.

The active isolation line 704 represents the frequency response achieved through ANC circuitry, which may be configured to attenuate low-frequency sounds. ANC functionality may involve the use of microphones to detect ambient noise and digital signal processors (DSPs) to generate anti-noise signals that cancel out these frequencies. The active isolation line 704 may demonstrate significant attenuation in the low-frequency range, typically below 1 kHz, where ANC is most effective. Higher frequencies may remain largely unaffected by ANC, as its primary focus is on persistent low-frequency noises, such as engine hums or air conditioning.

The combined isolation line 708 illustrates the frequency response achieved when passive isolation and active isolation are used together. The combined isolation line 708 may demonstrate attenuation across both low and high frequencies, resulting in a balanced audio experience. The circumaural earpads may reduce higher-frequency sounds, while the ANC circuitry may cancel out lower-frequency noises. Together, these mechanisms may create a “flat” frequency response, providing consistent attenuation across the audible range (approximately 20 Hz to 20 kHz). This flat response may be referred to as “world volume,” as it allows the user to perceive the surrounding environment in a controlled and comfortable manner. In some embodiments, this substantively flat response, or “world volume” is a desired frequency response for a user of the headphones. For instance a target of this “world volume” may be +/−10 dB over the frequency range, but in certain alternative embodiments, the “world volume” target may be +/−5 dB across the frequency range, or fewer dBs. In some embodiments, the targeted frequency range may be only a subset of the human audible range rather than the entirety of the human audible range.

The graph may highlight the importance of achieving a balanced frequency response. An imbalanced response—where certain frequency ranges are attenuated more than others—may result in a sound that feels unnatural or “strange” to the user. For example, excessive attenuation of low frequencies combined with insufficient passive isolation of high frequencies may create a hollow or distorted auditory experience. By combining passive and active isolation in a carefully tuned manner, the audio device may avoid this imbalance and provide a more comfortable and natural listening experience.

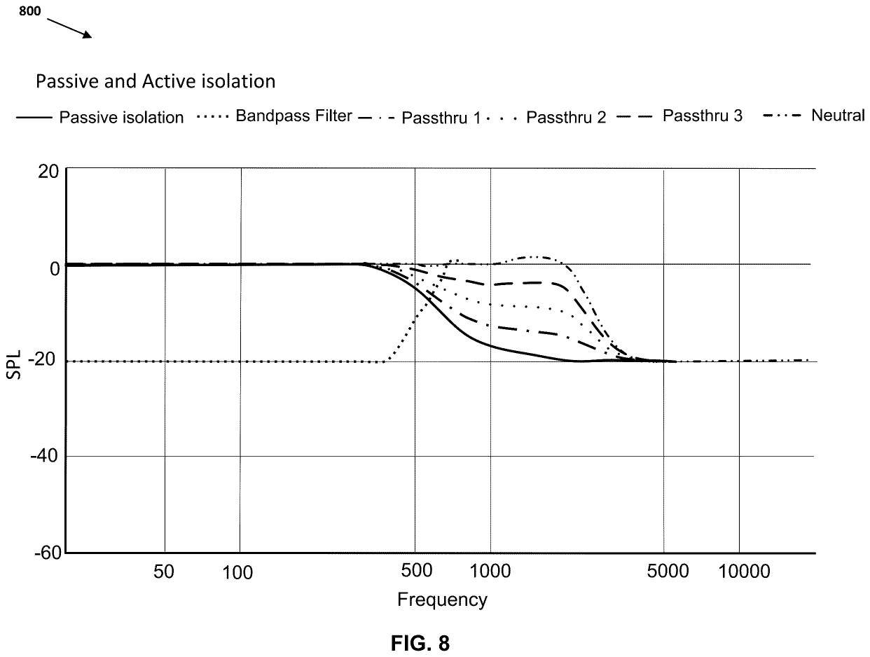

FIG. 8 illustrates a bandpass filter configuration used to tailor audio output based on user preferences for different frequency ranges such as voice along with other passthrough arrangements, according to certain embodiments of the present disclosure. The bandpass filter may represent a configurable mechanism that allows the user to control the type and characteristics of ambient sounds introduced into the audio device's output. In the embodiment shown in the graph in FIG. 8, this bandpass filter may cut lower frequencies. This functionality may compensate for passive isolation and provide a personalized auditory experience based on the user's preferences or situational needs.

The bandpass filter may be implemented within the audio device's passthrough circuitry, which may include microphones, analog-to-digital converters, amplifiers, and filters. Microphones positioned on the external surface of the device may capture ambient sounds from the surrounding environment and convert them into electrical signals. These signals may then be processed by the passthrough circuitry, which may apply bandpass filtering to isolate specific frequencies or ranges of frequencies based on the user's selected settings.

The bandpass filter may provide several options for the type of ambient content introduced into the headset's audio output. In some embodiments, the passthrough functionality may introduce all captured frequencies into the audio output, providing the user with a natural and comprehensive auditory experience. This configuration may include ambient sounds such as low frequencies associated with engine hums or vibrations, mid frequencies such as speech, and high frequencies such as alarms or sharp tones. Alternatively, the bandpass filter may be configured to isolate and amplify higher-frequency sounds, such as sharp tones, alarms, or high-pitched environmental noises. These upper frequencies may be prioritized in scenarios where users need to focus on safety-critical cues, such as traffic sounds or emergency alerts. The bandpass filter may also be configured to focus exclusively on speech frequencies, amplifying human voices while suppressing other ambient sounds. This setting may be useful in conversational environments, such as meetings, classrooms, or group discussions, where users need to prioritize verbal cues. In certain embodiments, the bandpass filter may allow users to define a custom frequency range for passthrough, such as selecting midrange frequencies for balanced speech and environmental awareness or emphasizing low frequencies for specific scenarios, such as detecting vibrations or bass-heavy sounds.

The audio device may allow users to amplify passthrough content above ambient noise levels. Amplification may involve boosting the captured sounds before transmitting them to the user via integrated speakers, ensuring that critical sounds are heard clearly even in noisy environments. The level of amplification may be adjustable, allowing users to fine-tune the boost based on their preferences or situational needs. Amplified passthrough may benefit users with hearing challenges by enhancing their ability to perceive speech or environmental sounds. In educational or instructional settings, amplified voice frequencies may assist users in focusing on spoken content without distractions. Amplifying safety-critical sounds, such as alarms or sirens, may improve the user's awareness of their surroundings in high-risk environments.

The passthrough functionality may include additional features to enhance user control and customization. In certain embodiments, the bandpass filter may integrate equalization settings that allow users to adjust the tonal balance of the passthrough content, such as emphasizing bass frequencies for music playback or treble frequencies for high-frequency awareness. Users may dynamically modify passthrough settings based on real-time environmental conditions, such as increasing voice amplification during a meeting and switching to full-spectrum passthrough while outdoors. The device may include an automatic detection feature that identifies and prioritizes relevant ambient sounds, such as speech or alarms, for passthrough, using algorithms or preset configurations to distinguish important frequencies from background noise.

The passthrough functionality may be adjustable via physical controls, such as dials, sliders, or buttons integrated into the audio device, or through a graphical interface on a connected device. Users may select their preferred passthrough mode and adjust amplification settings directly from the interface. In certain embodiments, the device may provide visual feedback, such as graphs, indicators, or animations, to show the effect of passthrough adjustments on the frequency response.

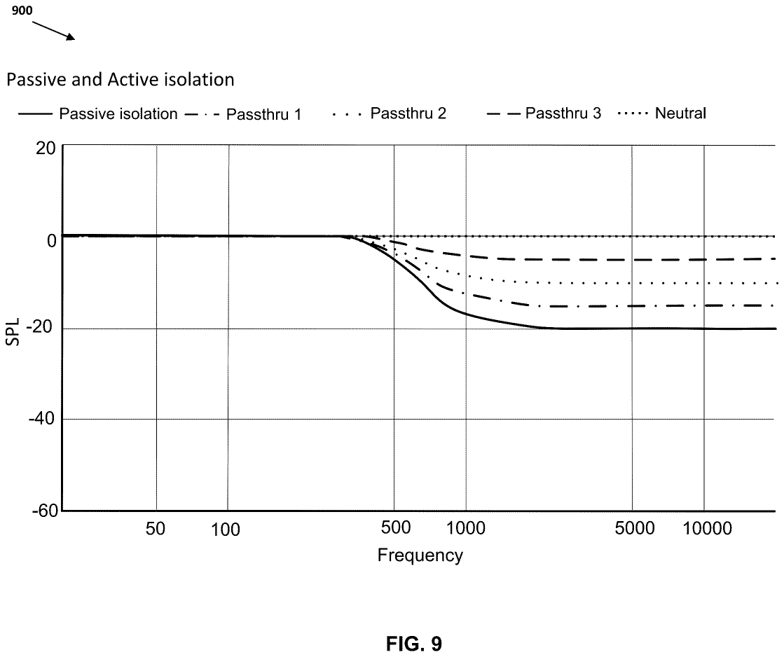

FIG. 9 demonstrates how passthrough functionality may compensate for passive isolation, according to certain embodiments of the present disclosure. The graph depicts the interplay between passive isolation and passthrough, showcasing how ambient sounds can be reintroduced into the user's auditory experience to create a balanced and controlled “world volume.”

Passive isolation, often achieved through circumaural ear pads or other sound-dampening materials, may effectively attenuate higher-frequency sounds by physically blocking sound waves. This attenuation may result in a quieter environment for the user, but it may also suppress important environmental sounds, such as speech or safety-critical cues like alarms or sirens. While passive isolation is effective for managing unwanted high-frequency noise, it can leave the user feeling disconnected from their surroundings, particularly in scenarios where situational awareness is important.

Passthrough functionality may counteract the effects of passive isolation by introducing selected ambient sounds into the audio device's output. Microphones positioned on the external surface of the device may capture sound waves from the surrounding environment, converting them into electrical signals. These signals may be processed by passthrough circuitry, which may amplify, filter, or otherwise modify the captured sounds before transmitting them to the user via integrated speakers. The passthrough circuitry may allow the user to control the level and type of ambient sounds introduced, enabling a tailored auditory experience.

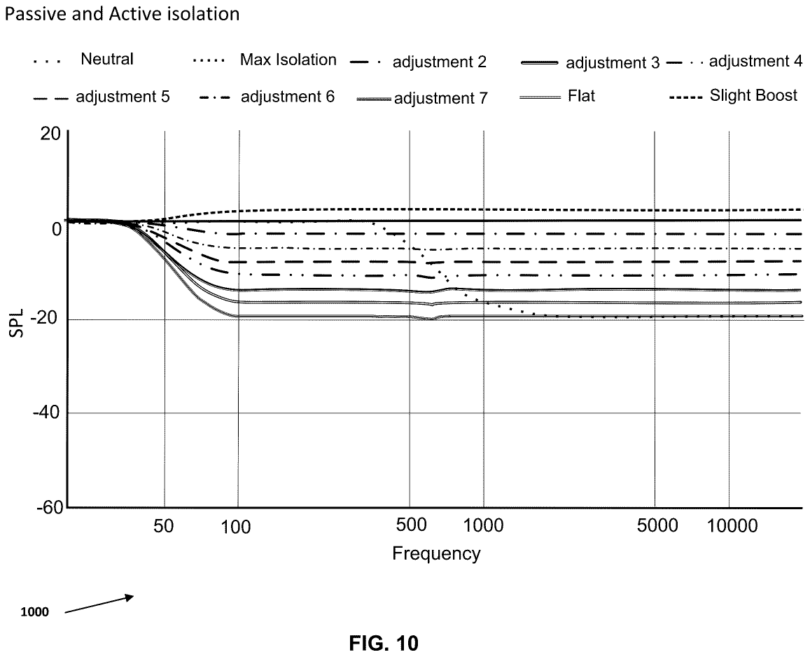

The integration of passthrough functionality with passive isolation may create a more balanced “world volume.” World volume refers to the controlled perception of ambient sounds, allowing users to hear their surroundings while still benefiting from the noise-dampening effects of passive isolation. For example, passthrough may allow speech frequencies to be amplified, ensuring that the user can engage in conversations or hear important verbal cues without removing the headset (as further shown in FIG. 10). Similarly, safety-critical sounds, such as sirens or alarms, may be selectively introduced through passthrough to maintain situational awareness.

The impact of passthrough on world volume may depend on several factors, including the level of passthrough gain, the frequency range of the introduced sounds, and the user's preferences. For example: At lower passthrough settings, ambient sounds may be introduced minimally, maintaining the quiet environment created by passive isolation. This configuration may be suitable for scenarios requiring focus, such as studying or meditation, where minimal distraction is desired. At moderate settings, passthrough may allow more ambient sounds to be introduced, creating a balanced auditory experience. For example, speech frequencies may be emphasized while background noise remains attenuated. This configuration may be ideal for conversational settings or work environments where awareness of surroundings is important. At higher passthrough settings, ambient sounds may be introduced at levels approaching their natural intensity, effectively compensating for the attenuating effects of passive isolation. This configuration may be suitable for outdoor use or safety-critical scenarios where full situational awareness is needed, such as walking in traffic-heavy areas or engaging in group activities.

The passthrough functionality may also include filters or equalization settings to ensure that only desired frequencies are introduced into the world volume. For example, the user may choose to amplify speech frequencies while suppressing background noise, such as construction sounds or wind. Alternatively, passthrough may be configured to prioritize safety-critical sounds, ensuring that alarms or sirens are heard clearly while other ambient sounds remain attenuated.

Any of the passthrough functionalities as shown in the graph may be adjustable via physical controls, such as dials or sliders, or through a graphical interface on a connected device. Users may dynamically modify passthrough settings based on their environment, preferences, or activity. For example, a user may increase passthrough gain in a busy office environment to hear conversations, then reduce it in a quiet library setting for focused work.

The combination of passive isolation and passthrough functionality may provide a versatile solution for managing world volume, allowing users to balance noise reduction with situational awareness by emphasizing the frequency ranges associated with human speech. This integration ensures that the user can maintain control over their auditory experience.

FIG. 10 illustrates a graphical representation showing an exemplary implementation for how “world volume” may be combined into a single control, according to certain embodiments of the present disclosure. When the device is turned on, and configured to create the audio performance shown in 1000, the audio device may activate ANC to complement the passive isolation provided by circumaural ear pads or other sound-dampening materials. ANC may attenuate low-frequency sounds, such as engine hums or air conditioning noise, while passive isolation may reduce higher-frequency sounds. Together, these mechanisms may create a flat frequency response, ensuring consistent attenuation across the audible range. This flat response may optimize the acoustic experience by minimizing distortions and imbalances that can occur when certain frequency ranges are over-or under-attenuated.

The control as previously described in the present disclosure may also add gain to the flat response, allowing users to amplify the “world volume” above the natural noise floor. The graphical representation may highlight several features and characteristics associated with this implementation. One advantage is that the flat frequency response achieved through the combination of ANC and passive isolation may provide an optimized acoustic experience, reducing unnatural distortions and maintaining consistency across all frequency ranges. This balanced response may improve user comfort and minimize auditory fatigue during extended use. In certain embodiments, the control may not have a transition between the “off” and “on” positions, resulting in a binary adjustment rather than a gradual change in noise isolation or passthrough levels. Additionally, the implementation may not include a means to fully “turn off” ANC, which may limit flexibility for users who prefer to rely solely on passive isolation or passthrough functionality. These limitations may be addressed in alternative embodiments by incorporating additional controls or settings to provide finer adjustments and greater customization.

The control may include a “neutral” performance position, which may correspond to a balanced configuration of ANC and passive isolation without added gain or passthrough. This position may serve as a default or reference point for users, allowing them to return to a baseline setting that provides natural attenuation of ambient sounds while maintaining acoustic balance. In certain embodiments, the neutral position may be marked or highlighted on the control interface to ensure easy identification and selection. The “neutral” performance position may be designed to have identical audio performance to what a user would experience if they removed the headset altogether.

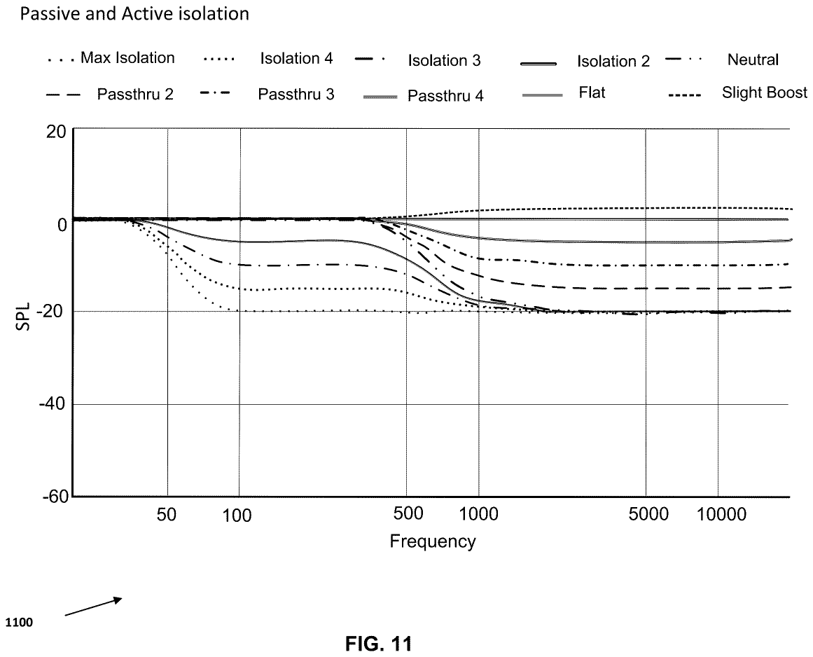

FIG. 11 illustrates a graphical representation showing an alternative implementation for how “world volume” may be combined into a single control, according to certain embodiments of the present disclosure. This figure demonstrates an alternative approach than the one shown in FIG. 10 to managing the audio device's noise isolation and passthrough from external microphone functionality, while still enabling users to adjust their auditory experience through a unified control mechanism that separates adjustments for active noise cancellation (ANC) and passthrough gain. The graphical representation highlights the division of the control into two distinct sections, each dedicated to modifying a specific aspect of the audio device's performance.

The first half of the control may be configured to adjust ANC attenuation, allowing users to manage the intensity of noise cancellation applied to low-frequency sounds. For example, moving the control within the first half may reduce ANC attenuation incrementally, transitioning from maximum noise cancellation to a complete deactivation of ANC. This range may allow users to select settings that balance low-frequency noise reduction with the preservation of natural environmental sounds, depending on their preferences or situational needs.

The second half of the control may be configured to adjust passthrough gain, enabling users to introduce ambient sounds into the audio device's output. Moving the control within the second half may amplify passthrough content, such as speech or environmental cues, while maintaining the attenuation effects of passive isolation. This range may provide users with the ability to increase situational awareness or focus on specific frequencies, such as human voices, without compromising the benefits of noise isolation.

The graphical representation may highlight several features associated with this implementation. One advantage is the natural transition between the “off” and “on” positions of ANC, which allows users to gradually deactivate or activate noise cancellation rather than switching between binary states. This smooth adjustment may provide a more intuitive user experience and reduce auditory discomfort associated with abrupt changes in noise isolation. Additionally, the distinct separation of ANC and passthrough adjustments in the control ensures that users can independently manage these features, providing greater flexibility and customization.

In certain embodiments, the frequency response achieved through this control may not be flat, as the independent adjustments for ANC and passthrough may result in varying levels of attenuation or amplification across different frequency ranges. Furthermore, the separation of ANC and passthrough adjustments may require users to understand how these features interact, potentially increasing the complexity of the control for some users.

Like the embodiment shown in 1000, the control may include a “neutral” performance setting, which may correspond to a balanced configuration of ANC and passthrough without excessive attenuation or amplification. This setting may serve as a default or reference point for users, allowing them to return to a baseline configuration that preserves natural environmental sounds while providing moderate noise isolation. The neutral position may be marked or highlighted on the control interface to ensure easy identification and selection.

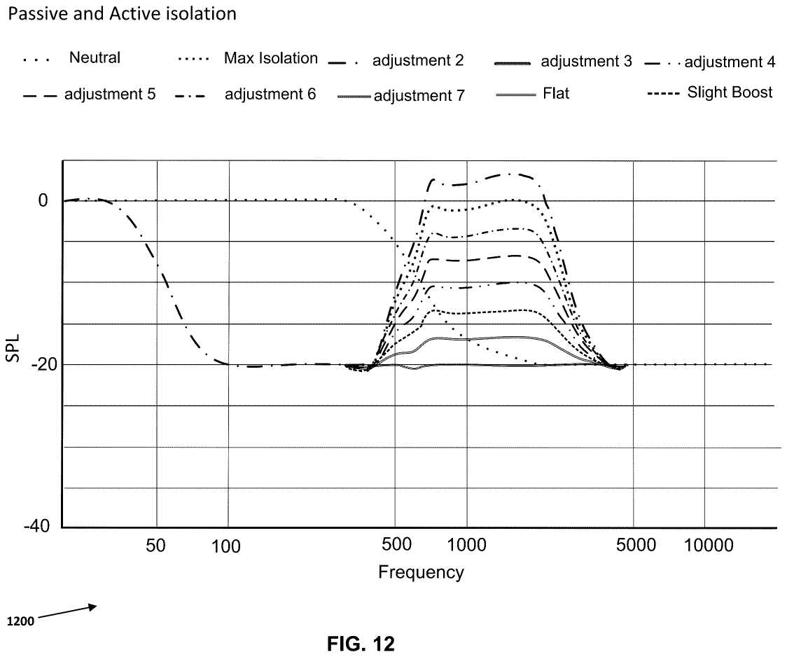

FIG. 12 illustrates a graphical representation showing another alternative implementation for how “world volume” may be combined into a single control, according to certain embodiments of the present disclosure. In this implementation, the control may be divided into two distinct sections, with the first half configured to adjust ANC attenuation and the second half configured to control passthrough gain. The control may enable users to selectively emphasize voice frequencies while suppressing low and high-frequency content.

When the control is in the “on” position, ANC may be activated to complement passive isolation, attenuating low-frequency sounds while maintaining the natural noise-dampening effects of physical barriers. As the control is adjusted through the passthrough gain section, increasing levels of voice frequencies may be amplified, allowing the user to prioritize speech clarity over other ambient sounds. This configuration may reject low-frequency hums and high-frequency sharp tones, ensuring that the audio output focuses on midrange frequencies associated with human voices.

The control may not include a neutral transition between off and on settings, resulting in a binary adjustment where ANC is either activated or deactivated without intermediate states. Additionally, the control may be designed to ensure that ANC remains active during operation, without the option to fully turn off noise cancellation. This implementation may be particularly suited for environments where speech clarity is the primary concern, such as meetings, classrooms, or instructional settings.

The described features may be configured in various ways depending on the embodiment, allowing flexibility in design while ensuring that the control supports selective emphasis on voice frequencies and rejection of unwanted ambient noise.

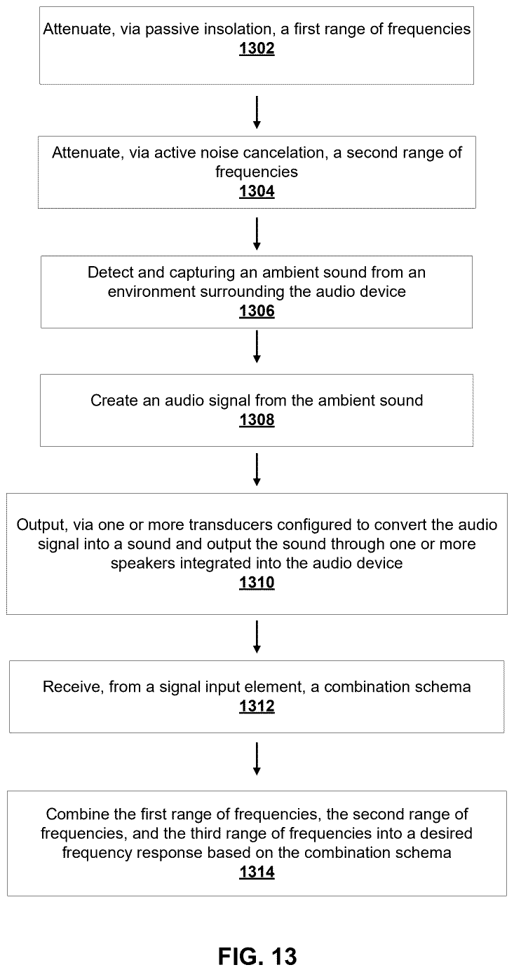

FIG. 13 illustrates a flowchart representing steps in a method for managing audio output in an audio device, according to certain embodiments of the present disclosure. The flowchart outlines a series of operations that may be performed to attenuate, introduce, process, and combine different ranges of frequencies to create a desired auditory experience for the user. Each step in the flowchart may be implemented using various components and configurations of the audio device, ensuring flexibility in design and functionality.

In step 1302, the method may attenuate a first range of frequencies via passive isolation. This step may involve the use of sound-dampening materials integrated into the earcups of the audio device, such as foam, fabric, or rubber. Passive isolation may primarily reduce higher-frequency sounds by creating a physical barrier that blocks sound waves from entering the user's auditory environment. The density, composition, and arrangement of the passive isolation materials may be tailored to achieve varying levels of attenuation, depending on the embodiment of the device and the user's preferences or settings.

In step 1304, the method may attenuate a second range of frequencies via active noise cancellation (ANC). This step may involve the use of microphones to detect ambient sounds and digital signal processors (DSPs) to generate anti-noise signals that counteract specific frequencies. ANC attenuation may focus on low-frequency sounds, such as engine hums or air conditioning noise, by producing sound waves that are phase-inverted relative to the incoming noise. The ANC circuitry may dynamically adjust its performance based on environmental conditions or user-selected settings, ensuring effective attenuation across the targeted frequency range.

In step 1306, the method may detect and capture ambient sound from the environment surrounding the audio device. Microphones positioned on the external surface of the device may collect sound waves from the surrounding environment, converting them into electrical signals for further processing. The microphones may be configured to capture a wide frequency range or focus on specific frequencies, such as speech or safety-critical sounds. In certain embodiments, the microphones may also include noise reduction features to enhance the clarity of captured sounds.

In step 1308, the method may create an audio signal from the captured ambient sound. This step may involve processing the electrical signals generated by the microphones using passthrough circuitry, which may include amplifiers, filters, or equalizers. The passthrough circuitry may modify the captured sounds to match user preferences or device settings, such as amplifying specific frequencies or suppressing background noise. The audio signal created may represent the desired ambient content that will be introduced into the user's auditory experience.

In step 1310, the method may output the processed audio signal via one or more transducers configured to convert the signal into sound and deliver it through speakers integrated into the audio device. The transducers may operate across the audible frequency range, approximately 20 Hz to 20 kHz. They may also operate in a wider frequency range to maximize audio fidelity. The speakers may be designed to balance the processed ambient sounds with the primary audio content, such as music or voice communication, providing a cohesive auditory experience.

In step 1312, the method may receive, from a signal input element, a combination schema. The signal input element may include physical controls, such as dials or sliders, or graphical controls displayed on a connected device. The combination schema may represent user-defined settings for blending the frequencies attenuated by passive isolation and ANC with the frequencies introduced via passthrough. The schema may include parameters for adjusting gain, equalization, or frequency prioritization, allowing users to tailor their auditory experience to their preferences or situational needs. For example, schemas for generating a “world volume” with a single control, in certain embodiments, are shown in FIGS. 10, 11 and 12.

In step 1314, the method may combine the first range of frequencies, the second range of frequencies, and the third range of frequencies into a desired frequency response based on the combination schema. The resulting frequency response may be confined to the audible range of approximately 20 Hz to 20 kHz, ensuring that all processed audio signals are perceptible to the user. The combination process may involve balancing the contributions of passive isolation, ANC, and passthrough to provide a controlled auditory environment referred to as “world volume.” This balanced response may allow users to perceive their surroundings while benefiting from noise reduction and audio clarity.

The flowchart represents a dynamic process that may be continuously or iteratively performed by the audio device, enabling real-time adjustments to noise isolation and passthrough settings based on environmental conditions or user input. The described steps may be implemented in various configurations depending on the embodiment of the audio device, ensuring adaptability for different use cases and user preferences.

While the foregoing description includes specific embodiments and examples, these are intended to illustrate the principles of the invention and should not be construed as limiting the scope of the invention. Numerous modifications, variations, and alternative configurations may be made to the described embodiments without departing from the spirit and scope of the invention. For example, components described herein may be implemented using alternative materials, arrangements, or methods of operation depending on user preferences, manufacturing constraints, or technological advancements.

The terms used in the specification are descriptive rather than limiting, and the scope of the invention should be determined by the appended claims. Any reference to particular features or configurations should not be interpreted as requiring such features or configurations unless explicitly stated in the claims. Additionally, elements described as optional or configurable may be omitted, replaced, or combined with other elements in various embodiments.

The invention may be implemented in hardware, software, firmware, or any combination thereof, and may be embodied in physical devices, digital systems, or virtual interfaces. The described embodiments are intended to encompass all such implementations, including future modifications or improvements that achieve similar functionality.

Any numerical ranges or values provided in the specification are intended to represent approximate boundaries, and variations outside these ranges may still fall within the scope of the invention. Similarly, references to particular standards, protocols, or technologies are intended for illustrative purposes and may be substituted with equivalent or alternative approaches.

The embodiments described herein may be practiced in isolation or in combination with other systems, devices, or techniques, depending on the specific application or use case. The invention is not limited to any particular field or industry and may be adapted to meet the needs of diverse environments or user groups.

It should also be understood that references to directional terms such as “top,” “bottom,” “left,” or “right” are relative and intended only for illustrative purposes based on the orientation depicted in the figures. These terms should not be construed as limiting the physical arrangement or placement of components.

The scope of the invention should not be limited by the examples provided but should instead be determined by the claims and their equivalents, including any amendments or variations that may arise during prosecution.

What is claimed is:

1. A method of controlling an audio device, the method comprising
attenuating, via passive insolation, a first range of frequencies;
attenuating, via active noise cancelation, a second range of frequencies;
introducing, via passthrough from one or more microphones on the audio device, a third range of frequencies, the introducing comprising:
detecting and capturing an ambient sound from an environment surrounding the audio device;
creating an audio signal based on the ambient sound;
outputting, via one or more transducers configured to convert the audio signal into a sound and output the sound through one or more speakers integrated into the audio device;
receiving, from a signal input element, a combination schema; and
combining the first range of frequencies, the second range of frequencies, and the third range of frequencies into a desired frequency response based on the combination schema.

2. The method of claim 1, in which the desired frequency response is a substantively flat audio response.

3. The method of claim 2, in which the combination schema adds gain to the flat audio response.

4. The method of claim 1, in which the combination schema is modified via a dial situated on a first earphone on the audio device.

5. The method of claim 4, in which a first portion of a setting adjustable via the dial modifies an amount of attenuation from active noise cancelation, and a second portion of the settings adjustable via the dial modifies an amount of gain from passthrough.

6. The method of claim 4, in which adjusting the dial increases a level of voice frequencies in comparison to an environmental baseline volume.

7. The method of claim 4, in which a volume of the audio device is adjustable via an additional dial situated on a second earphone on the audio device.

8. The method of claim 1, in which introducing, via passthrough from one or more microphones on the audio device, a third range of frequencies, further comprises:
amplifying specific frequencies associated with a human voice.

9. The method of claim 2, further comprising:
decreasing a system volume lower than an environmental baseline volume; and
engaging a visual indicator capable of displaying that the audio device has decreased the system volume.

10. The method of claim 9, wherein the visual indicator is a number of LEDs coupled to one or both of a first earphone or a second earphone on the audio device.

11. The method of claim 9, wherein the visual indicator is a color of LEDs coupled to one or both of a first earphone or a second earphone on the audio device.

12. The method of claim 9, wherein the system volume gradually and automatically returns to an environmental baseline volume over a configurable time period.

13. The method of claim 5, in which there exists a neutral performance setting, wherein the neutral performance setting corresponds to an environmental baseline volume.

14. The method of claim 1, further comprising:
modifying the passive insolation by adjusting a physical characteristic of the audio device, wherein the audio device is capable of being adjusted while worn.

15. A system comprising:
a pair of earphones, the pair of earphones being configured to:
attenuate, via passive insolation, a first range of frequencies;
attenuate, via active noise cancelation, a second range of frequencies;
introduce, via passthrough from external microphones on the pair of earphones detecting and capturing an ambient sound from an environment, a third range of frequencies;
receiving, from a signal input element, a combination schema; and
combining the first range of frequencies, the second range of frequencies, and the third range of frequencies into a desired frequency response based on the combination schema.

16. The system of claim 15, further comprising:
the pair of earphones being configured to perform operations including:
matching active noise cancelling with passive isolation to create a flat audio response; and
a first dial coupled to a first earphone on the pair of earphones, configured to perform operations including:
adding gain to the flat audio response.

17. The system of claim 15, further comprising:
the pair of earphones being configured to perform operations including:
matching active noise cancelling with passive isolation to create a flat audio response;
a first dial coupled to a first earphone on the pair of earphones, the first dial comprising a first half and a second half;
the first half configured to perform operations including:
raising and lowering a level of active noise cancelling attenuation;
and the second half configured to perform operations including:
raising and lowering a level of passthrough gain.

18. The system of claim 17, wherein a flat audio response is maintained throughout.

19. The system of claim 16, further comprising:
a neutral setting on the first dial, capable of generating an environmental baseline world volume.

20. The method of claim 12, wherein usage statistics relating to deployment of an audio device's focus features are aggregated and displayed.

21. A method of controlling an audio device, the method comprising:
attenuating, via passive isolation, a first range of frequencies;
attenuating, via active noise cancellation, a second range of frequencies;
introducing, via passthrough from external microphones on the audio device detecting and capturing an ambient sound from an environment, a third range of frequencies;
transitioning the audio device from a first state to a second state via a transitional mode, wherein the transitional mode includes:
receiving, from a signal input element, a combination schema to configure the transitional mode and its parameters; and
blending levels of attenuation from passive isolation, active noise cancellation, and passthrough gain based on the combination schema.

22. The method of claim 21, wherein the transitional mode is triggered by at least one of:
detecting a predefined user input on a physical control interface of the audio device;
receiving a signal from a connected external device; or
detecting environmental changes based on ambient sound captured by the microphones.

23. The method of claim 21, wherein a duration of the transitional mode is adjustable and configured to complete over a predefined time period ranging from 1 second to 1 hour.

24. The method of claim 21, further comprising:
engaging a visual indicator during the transitional mode to display a progression of the transition, wherein the visual indicator comprises a plurality of LEDs or an LED array that dynamically updates.

25. The method of claim 21, wherein the combination schema includes parameters for:
defining the range of frequencies blended during the transitional mode;
specifying a rate of change for attenuation and passthrough gain during the transition.

26. The method of claim 21, wherein the first range of frequencies, the second range of frequencies, and the third range of frequencies are different frequency ranges.
